(19) United States
(12) Patent Application Publication
(10) Pub. No.: US 2006/0206414 A1
(43) Pub. Date: Sep. 14, 2006

(54) Convertible debenture annuity trust investment device and method therefor

(75) Inventor: John Warren Larson, Scottsdale, AZ (US)

Correspondence Address: WEISS & MOY PC, 4204 NORTH BROWN AVENUE, SCOTTSDALE, AZ, 85251, US

(73) Assignee: OMNI CAPITAL FUNDING, INC.

(21) Appl. No.: 11/074,617

(22) Filed: Mar. 8, 2005

(51) Int. Cl. G06Q 40/00

(52) U.S. Cl. 705/38

(57) ABSTRACT

A method for generating capital for a corporation while protecting investors comprises: establishing a statutory funding trust under the laws of a designated state pursuant to a trust agreement; offering of debentures by the funding trust in a predetermined amount; loaning a portion of funds generated from sale of the debentures to the corporation; and purchasing different annuities which are owned by the funding trust.

### BACKGROUND OF THE INVENTION

1. Field of the Invention

This invention relates generally to finances, and more specifically, to a convertible debenture annuity trust which is a funding instrument to generate working capital and which is built upon a trust to protect the investors and the company.

2. Description of the Prior Art

The problem in today's investment world is that a company that has sold an A+ Rated investment bond that pays out in 20-30 years may not even be in business when the bonds vest. There are many companies that have gone under for numerous reasons leaving the investors holding worthless paper. In the event of receivership of a Corporation the pecking order of creditors is usually long and distinguished, but the bondholders are usually not the first priority.

The recourse for most investors is a class action lawsuit. Even if the investors win, a settlement may take years in order to find out the end payment to the investors. In most class actions suits, the settlement is usually pennies on the dollar.

Therefore, there is a need for an investment vehicle that overcomes the above problems. The investment vehicle needs to be able to raise funds for a corporation while also being safe so that in the event the company that the funds have been raised for should go into receivership, the majority of the investment dollars are held sole and separate. The investment vehicle needs to be safe so that in the event the company that the funds have been raised should go into receivership, payment to investors will be approximately eighty percent or more.

### SUMMARY OF THE INVENTION

In accordance with one embodiment of the present invention, it is an object of the present invention to provide an investment vehicle that overcomes the problems associated with prior art investment vehicles.

It is another object of the present invention to provide an investment vehicle that is able to raise funds for a corporation while also being safe so that in the event the company that the funds have been raised for should go into receivership, the majority of the investment dollars are held sole and separate.

It is still another object of the present invention to provide an investment vehicle that is safe so that in the event the company that the funds have been raised for should go into receivership, payment to investors will be approximately eighty percent or more.

### BRIEF DESCRIPTION OF THE EMBODIMENTS

In accordance with one embodiment of the present invention, a method for generating capital for a corporation while protecting investors is disclosed. The method comprises: establishing a statutory funding trust under the laws of a designated state pursuant to a trust agreement; offering of debentures by the funding trust in a predetermined amount; loaning a portion of funds generated from sale of the debentures to the corporation; and purchasing different annuities which are owned by the funding trust.

In accordance with another embodiment of the present invention, a method for generating capital for a corporation while protecting investors is disclosed. The method comprises: establishing a statutory funding trust under the laws of a designated state pursuant to a trust agreement; offering of debentures by the funding trust in a predetermined amount; loaning a portion of funds generated from sale of the debentures to the corporation; purchasing different annuities which are owned by the funding trust; and offering an equity interest in the corporation for raising additional capital.

The foregoing and other objects, features, and advantages of the invention will be apparent from the following, more particular, descriptions of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a block diagram of the present invention.

FIG. 1A is a block diagram depicting Step 1 of the present invention.

FIG. 2 is a block diagram depicting Step 2 of the present invention.

FIG. 3 is a block diagram depicting Step 3 of the present invention.

FIG. 4 is a block diagram depicting Step 4 of the present invention.

FIG. 5A is a block diagram depicting one alternative for Step 5 of the present invention.

FIG. 5B is a block diagram depicting a second alternative for Step 5 of the present invention.

FIG. 6 is a block diagram depicting Step 6 of the present invention.

FIG. 7 is a block diagram depicting Step 7 of the present invention.

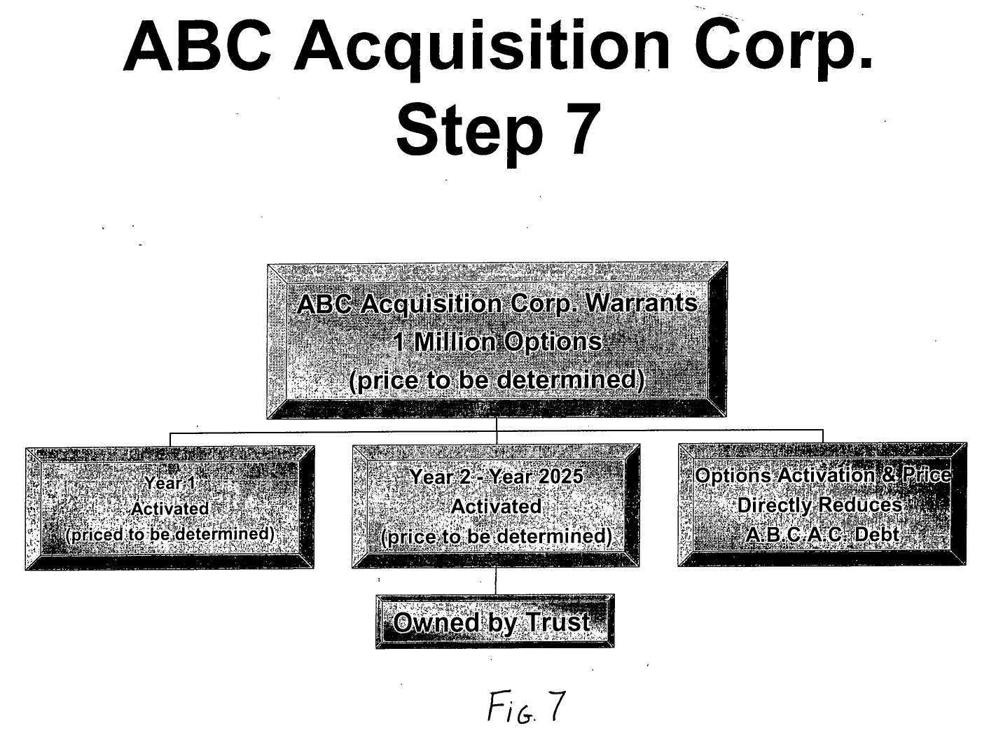

### DETAILED DESCRIPTION OF THE PREFERRED EMBODIMENT

Referring to the Figures, a new investment vehicle is described. The investment vehicle is used to generate working capital for a start-up corporation and is built upon a trust to protect the investors and the corporation.

The investment vehicle is called a Convertible Debenture Annuity Trust. The Convertible Debenture Annuity Trust is a funding instrument that is built inside of a trust to protect the investor and the company. The trust has five levels of security: 1) the Trust itself; 2) the trust has a separate trustee; 3) Administrative Agent that oversees everyone; 4) fourth level of security for the investor and company is that a majority (80%) of the invested dollars are held in Annuities in Insurance Companies with A+ rating; and 5) the fifth level is a separate payment Agent.

The Convertible Debenture Annuity trust is a twenty year structure. The majority of the investment dollars are held in very safe and reliable vehicles over the twenty years. In the event that the company that the funds have been raised for should go into receivership, the majority of the investors' dollars are held sole and separate. All of the Annuities and Life insurance in the structure are collateralized to the investor through the Trust. Thus, the Convertible Debenture Annuity Trust protects the investors. The worst case scenario with the Convertible Debenture Annuity Trust in the first year would be approximately 80% and more as the year's progress.

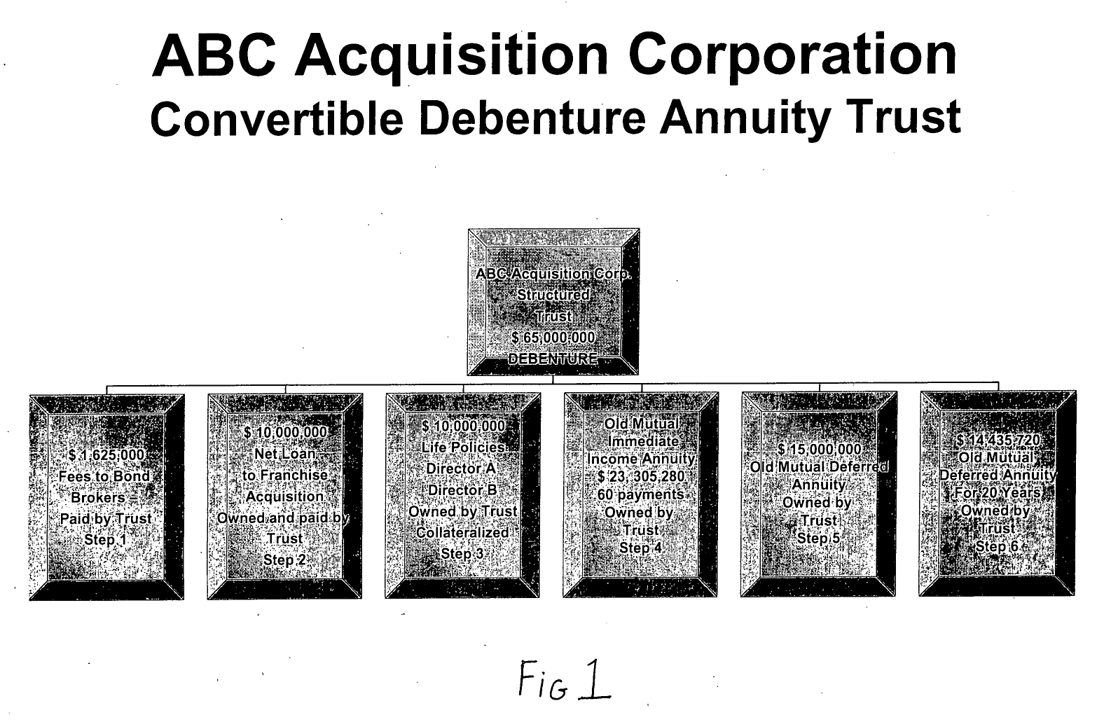

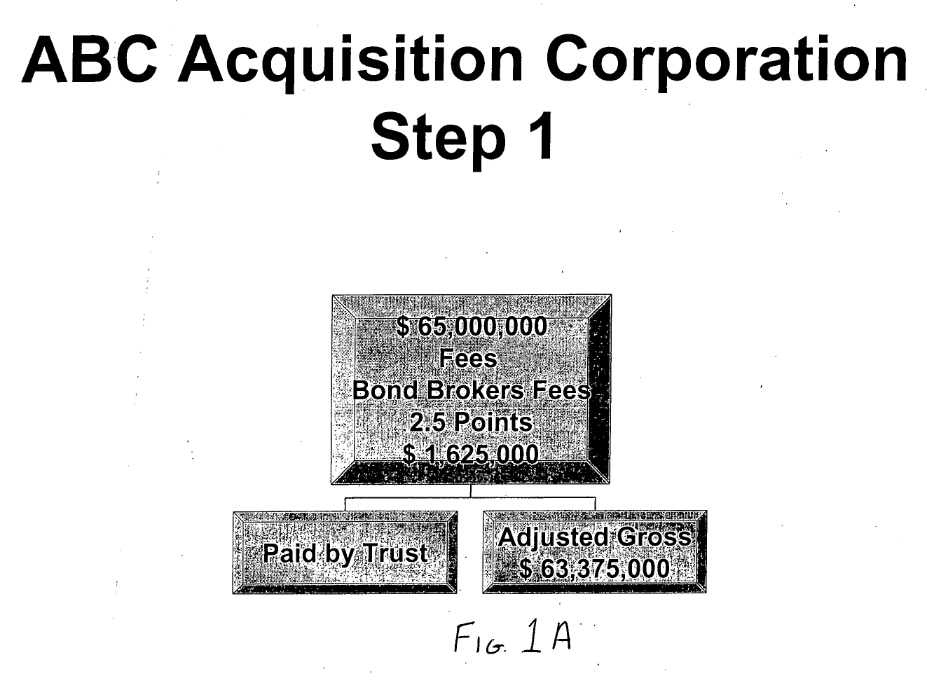

The Trust works in the following manner. As seen in FIG. 1, an Acquisition Corporation Funding Trust is established. The Acquisition Corporation Funding Trust will be a statutory trust established under the laws of a designated state pursuant to the Trust agreement. The Trust agreement constitutes the “governing instrument” under the laws of the designated state relating to statutory trust. After the formation of the Trust, the Trust will not engage in any activity other than: 1) issuing Debentures, 2) purchasing annuities and making the distribution; 3) making payments on the Debentures, and 4) engaging in other activities that are necessary, suitable, incidental, or connected to the above. The Trust is subject to certain provisions in the Trust Agreement that limits the Trust's activities and to minimize the possibility that the Trust will voluntarily make itself the subject of a bankruptcy proceeding.

The Acquisition Corporation Funding Trust will offer Debentures in a predetermined amount. The Debentures will generally not be registered with the Securities Act of 1933 or the securities laws of any state. The Debentures are offered and sold in reliance on exemptions from the registration requirements of such laws. There will be restrictions imposed by federal and state securities laws upon the resale or transfer of the Debentures except by gift, bequest, or operation of law. The Debentures, which are “restricted securities” as defined in Rule 144 promulgated under the Securities Act, must be held indefinitely unless they are subsequently registered under the Securities Act and any applicable state securities laws or unless, upon the advice of legal counsel satisfactory to the Trust, they may be sold in a transaction that is exempt from registration requirements of such laws.

In order to purchase a Debenture, a prospective purchaser will need to execute and deliver a Subscription Agreement to the Trust. The Subscription Agreement must be submitted to the Trust with payment. The Trust has the right to amend or terminate the offering. The Trust also reserves the right to reject any offer to purchase the Debentures for any reason.

In general, the Trust will use the proceeds for the benefit of the Acquisition Corporation Funding Trust. The Trust will use the proceeds to pay for the expenses of the Offering, to purchase Annuities, and to distribute the remaining funds to the Corporation. The proceeds from the Offering received by the Corporation will be used for corporate business such as, but not limited to, pursuing customers for the Company's applications, to enhance the Company's cash position, to make acquisitions, and for other general corporate purposes.

As shown in the Figures, the Trust will initially use part of the proceeds of the Offering to pay for expenses connected to the Offering. In general, Bond Brokers will have fees associated with the Offering. For example, if the Bond Broker assesses a 2.5 point fee for an Offering in the amount of $65,000,000, the expenses associated with the Offering would amount to $1,625,000.

Part of the proceeds is to be used as a loan to the Corporation. The Corporation will use these funds the Corporation receives from the Offering to pursue customers, enhance the Corporation's cash position, to hire personnel, and for other corporate purposes.

The remainder of the proceeds is used to purchase different annuities which are owned by the Trust and collateralized to the investors until the debt is paid. The majority of the investment dollars are held in very safe and reliable vehicles over the twenty years. In the event that the company that the funds have been raised for should go into receivership, the majority of the investors' dollars are held sole and separate. All of the Annuities and Life insurance in the structure are collateralized to the investor through the Trust. Thus, the Convertible Debenture Annuity Trust protects the investors. The worst case scenario with the Convertible Debenture Annuity Trust in the first year would be approximately 80% and more as the year's progress.

A deferred annuity is purchased which is used to pay for the Life premiums of life policies for one or more directors of the Corporation. The life polices are purchased to protect the Corporation and the investors in the event of a premature death of one of the key executives of the Corporation. The life policies are twenty year term policies with premiums held in a return of premiums Annuity to pay the premiums for the next twenty years. An immediate income annuity is purchased. The immediate income annuity is used to pay the interest due on the Debentures in the near term. These payments are guaranteed to the investors. In accordance with one embodiment of the present method, the immediate income annuity is used to pay the interest due on the Debentures for the first five years. Another deferred annuity is purchased. The second deferred annuity is used to pay the interest on the Debentures for the middle term of the twenty years (i.e., year six through nine and a half). Again, these payments are guaranteed to the investors. A third deferred annuity is purchased. The third deferred annuity is used to pay interest and principal on the maturity date of the Debentures. These payments are also guaranteed to the investors.

Referring now to the Figures, an example will be discuss. The Acquisition Corporation Funding Trust will offer Debentures in an amount of sixty-five million dollars for a Corporation. The Trust will use the proceeds to pay for the expenses of the Offering, to purchase Annuities, and to distribute the remaining funds to the Corporation. As shown in FIG. 1A, the Trust will initially use part of the proceeds of the Offering to pay for expenses connected to the Offering. In general, Bond Brokers will have fees associated with the Offering. In FIG. 1A, if the Bond Broker assesses a 2.5 point fee for an Offering in the amount of $65,000,000, the expenses associated with the Offering would amount to $1,625,000. Thus leaving and adjusted gross of $63,375,000.

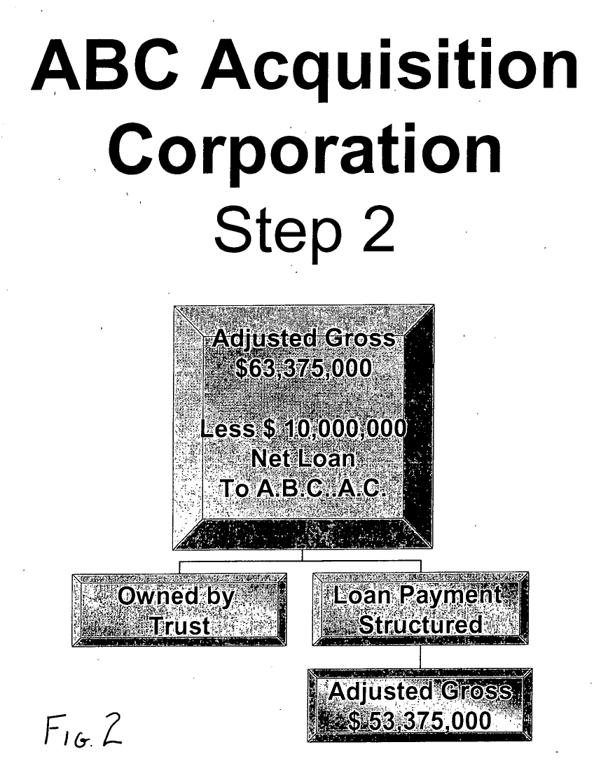

Referring now to FIG. 2, part of the proceeds is to be used as a loan to the Corporation. The Corporation will use these funds the Corporation receives from the Offering to pursue customers, enhance the Corporation's cash position, to hire personnel, and for other corporate purposes. As seen in FIG. 2, a $10,000,000 loan is made to the Corporation leaving an adjusted gross of $53,375,000.

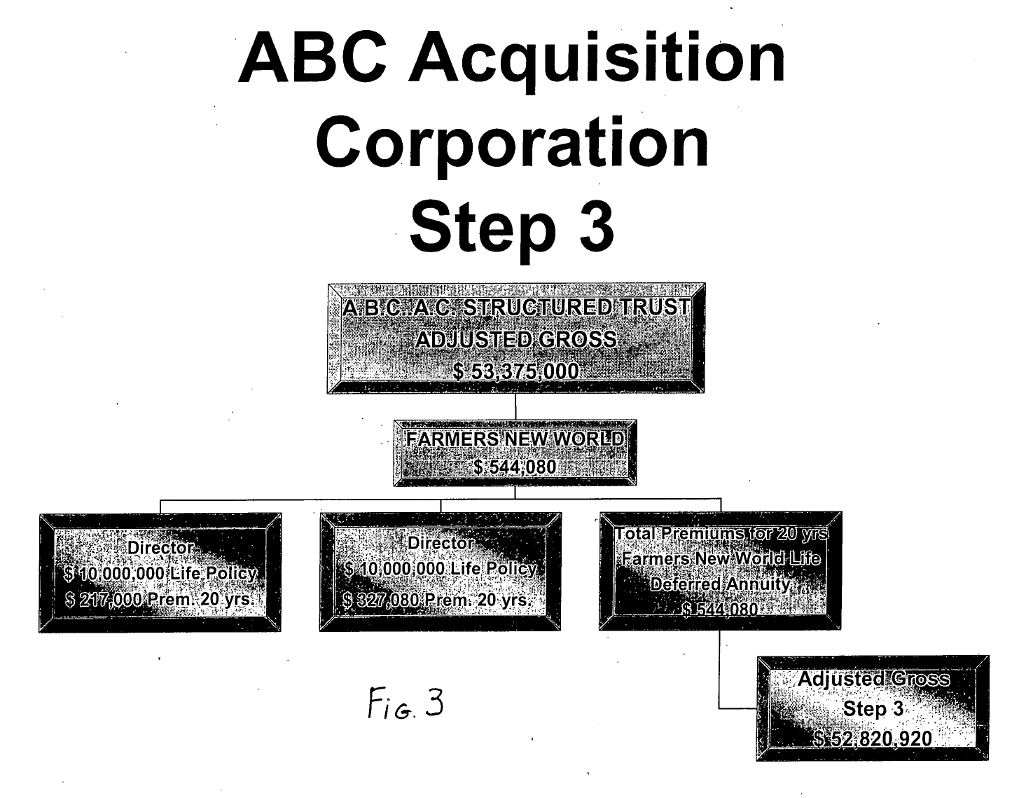

The remainder of the proceeds is used to purchase different annuities which are owned by the Trust. A deferred annuity is purchased which is used to pay for the Life premiums of life policies for one or more directors of the Corporation. As seen in FIG. 3, $544,080 is used to purchase a Farmers New World Life Deferred Annuity to pay for Life Policies on two Directors of the Corporation. As seen in FIG. 3, the money used to purchase the Farmers New World Life Deferred Annuity leaves an adjusted gross of $52,820,920.

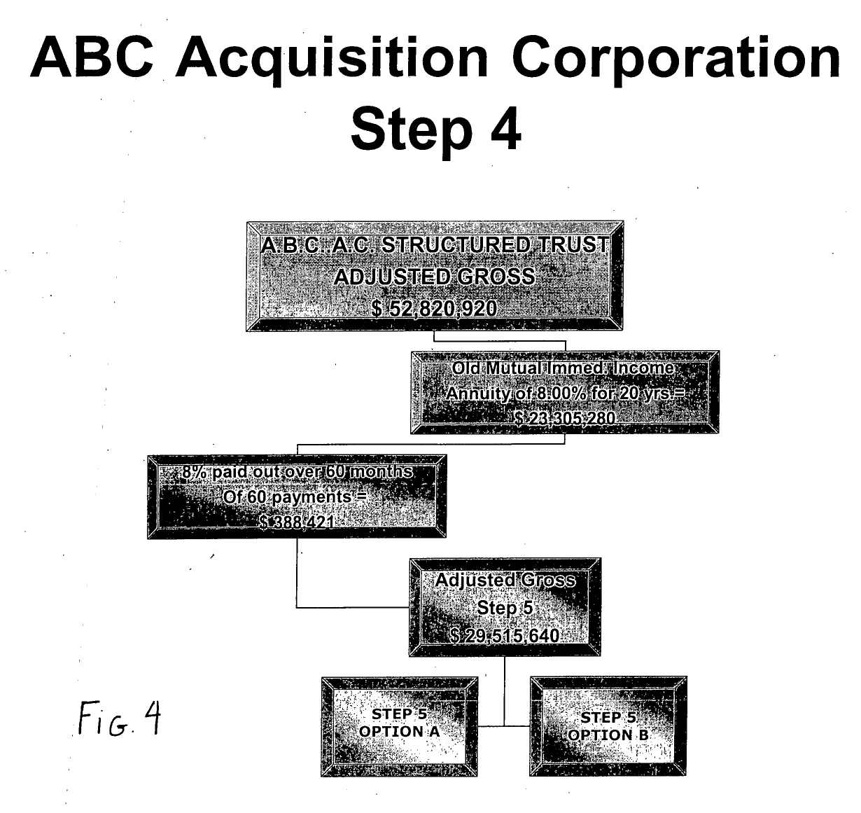

Referring to FIG. 4, an immediate income annuity is purchased to pay the interest due on the Debentures in the near term. In accordance with the embodiment depicted in FIG. 4, the immediate income annuity is used to pay the interest due on the Debentures for the first five years. In FIG. 4, $23,305,280 is used to purchase an Old World Immediate Income Annuity of 8.0% for twenty years. The Annuity would pay out $388,421 per month for the first five years which would be used to pay the interest due on the Debentures. After the purchase of the Annuity, an adjusted gross of $29,515,640 remains.

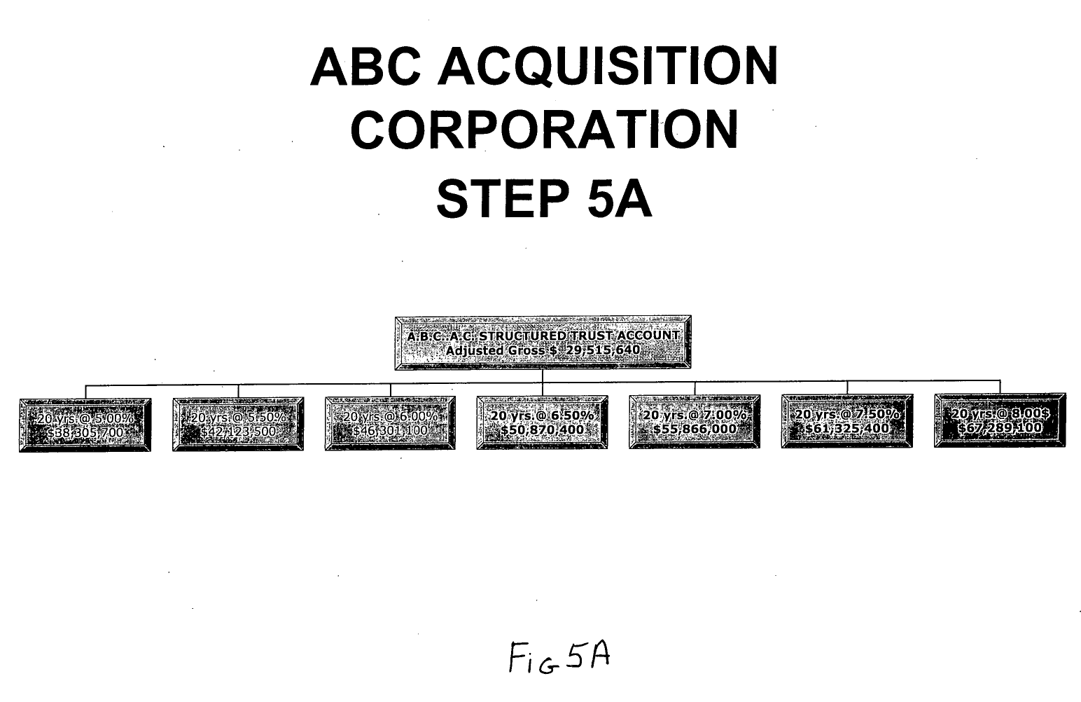

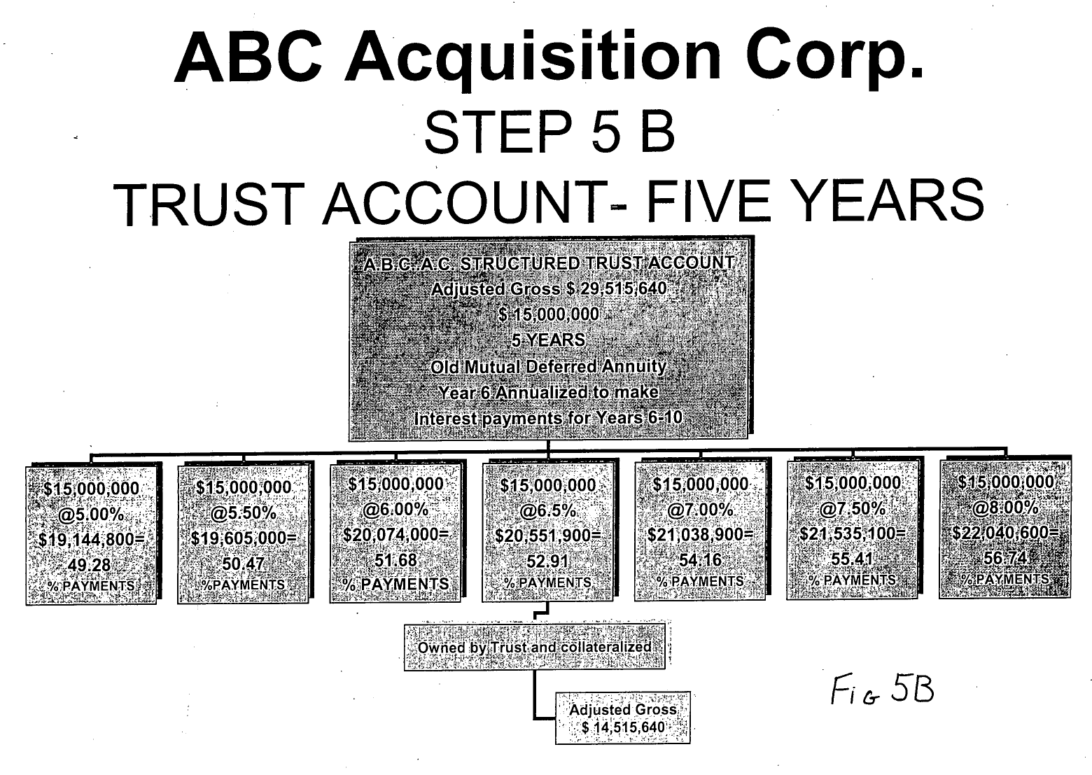

Referring to FIGS. 5A and 5B, a second deferred annuity is used to pay the interest on the Debentures for the middle term of the twenty years (i.e., year six through nine and a half). In FIGS. 5A and 5B, $15,000,000 is used to purchase a deferred annuity to pay for the interest on the Debentures for years six through ten. After the purchase of the Annuity, an adjusted gross of $14,515,640 remains.

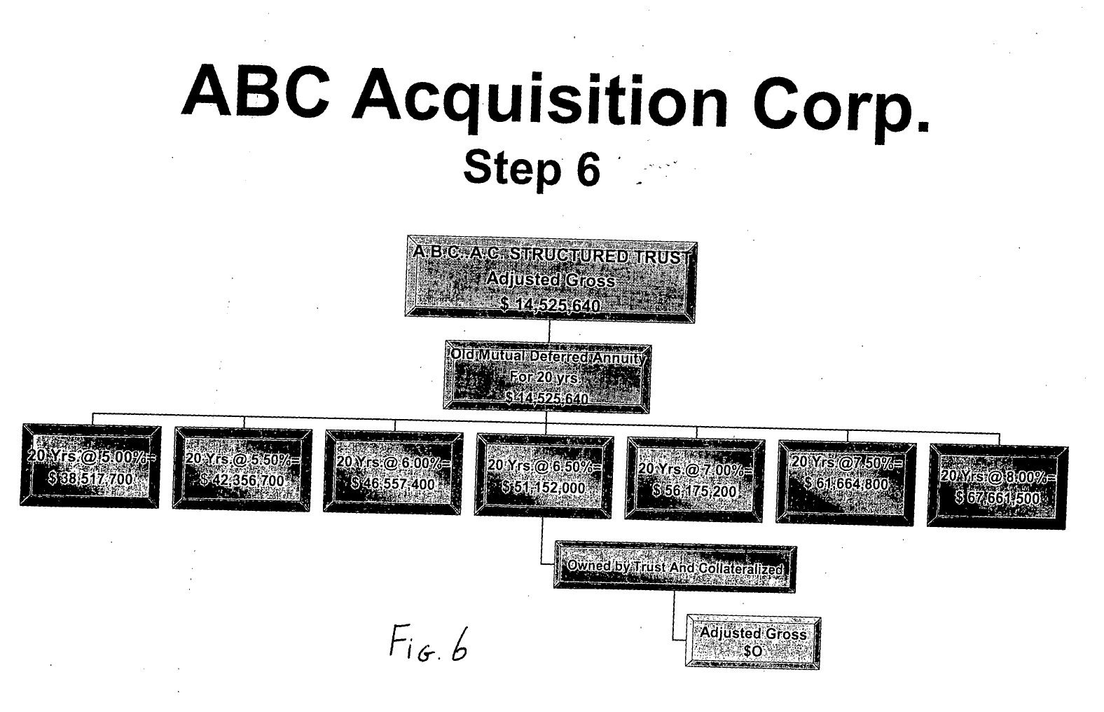

Referring to FIG. 6, the remaining funds generated from the sale of the debentures is used to purchase a third deferred annuity. The third deferred annuity is used to pay interest and principal on the maturity date of the Debentures. FIG. 6 shows the returns for twenty years with different interest rates.

In order to generate more income and to preserve cash, the Corporation may use various forms of equity as payment. Increasingly, advisors, landlords and others may be willing to forgo an immediate cash payment in exchange for an equity stake in the Corporation. This equity interest may take the form of preferred stock, common stock, options or warrants to purchase stock at a later date at a fixed price. For example, the Corporation may issue Warrants in order to raise Capital for 10% of the value of the Debentures. The options can be activated for a lesser amount in the first eighteen months and at a higher amount for nineteen months out to twenty years.

While the invention has been particularly shown and describe with reference to preferred embodiments thereof, it will be understood by those skilled in the art that the foregoing and other changes in form and details may be made therein without departing from the spirit and scope of the invention.

What is claimed is:

1. A method for generating capital for a corporation while protecting investors comprising:
establishing a statutory funding trust under the laws of a designated state pursuant to a trust agreement;
offering of debentures by the funding trust in a predetermined amount;
loaning a portion of funds generated from sale of the debentures to the corporation; and
purchasing different annuities which are owned by the funding trust.

2. A method for generating capital for a corporation while protecting investors in accordance with claim 1 further comprising issuing warrants for raising additional capital.

3. A method for generating capital for a corporation while protecting investors in accordance with claim 1 wherein offering of debentures by the funding trust further comprises paying fees associated with the offering of the debentures with proceeds from the Offering.

4. A method for generating capital for a corporation while protecting investors in accordance with claim 1 wherein loaning a portion of funds generated from sale of the debentures to the corporation further comprises loaning a portion of funds generated from sale of the debentures to the corporation wherein the loan is owned and paid by the statutory funding trust.

5. A method for generating capital for a corporation while protecting investors in accordance with claim 1 wherein purchasing different annuities further comprises purchasing different annuities which are owned by the statutory funding trust and collateralized to investors until debt is paid.

6. A method for generating capital for a corporation while protecting investors in accordance with claim 5 wherein purchasing different annuities further comprises purchasing at least one deferred annuity which is used to pay for a life premiums of life policies for one or more directors of the corporation.

7. A method for generating capital for a corporation while protecting investors in accordance with claim 5 wherein purchasing different annuities further comprises purchasing an immediate income annuity to pay interest due on the debentures in a near term of life of the debentures.

8. A method for generating capital for a corporation while protecting investors in accordance with claim 5 wherein purchasing different annuities further comprises purchasing at least one deferred annuity to pay the interest on the debentures during a mid-term of a life of the debentures.

9. A method for generating capital for a corporation while protecting investors in accordance with claim 5 wherein purchasing different annuities further comprises purchasing at least one deferred annuity to pay interest and principal on the maturity date of the debentures.

10. A method for generating capital for a corporation while protecting investors comprising:
establishing a statutory funding trust under the laws of a designated state pursuant to a trust agreement;
offering of debentures by the funding trust in a predetermined amount;
loaning a portion of funds generated from sale of the debentures to the corporation;
purchasing different annuities which are owned by the funding trust; and
offering an equity interest in the corporation for raising additional capital.

11. A method for generating capital for a corporation while protecting investors in accordance with claim 10 wherein offering an equity interest in the corporation for raising additional capital comprises at least one of: offering preferred stock, offering common stock, offering options or offering warrants to purchase stock at a later date at a fixed price.

12. A method for generating capital for a corporation while protecting investors in accordance with claim 10 wherein offering of debentures by the funding trust further comprises paying fees associated with the offering of the debentures with proceeds from the offering of the debentures.

13. A method for generating capital for a corporation while protecting investors in accordance with claim 10 wherein loaning a portion of funds generated from sale of the debentures to the corporation further comprises loaning a portion of funds generated from sale of the debentures to the corporation wherein the loan is owned and paid by the statutory funding trust.

14. A method for generating capital for a corporation while protecting investors in accordance with claim 10 wherein purchasing different annuities further comprises purchasing different annuities which are owned by the statutory funding trust and collateralized to investors until debt is paid.

15. A method for generating capital for a corporation while protecting investors in accordance with claim 14 wherein purchasing different annuities further comprises purchasing a first deferred annuity which is used to pay for life premiums of life policies for one or more directors of the corporation.

16. A method for generating capital for a corporation while protecting investors in accordance with claim 15 wherein purchasing different annuities further comprises purchasing an immediate income annuity to pay interest due on the debentures in a near term.

17. A method for generating capital for a corporation while protecting investors in accordance with claim 16 wherein purchasing different annuities further comprises purchasing a second deferred annuity to pay the interest on the debentures during a mid-term of life of the debentures.

18. A method for generating capital for a corporation while protecting investors in accordance with claim 17 wherein purchasing different annuities further comprises purchasing a third deferred annuity to pay interest and principal on the maturity date of the debentures.
